(19) United States
(12) Patent Application Publication
(10) Pub. No.: US 2013/0279164 A1
(43) Pub. Date: Oct. 24, 2013

(54) LED LIGHTING FIXTURES

(71) Applicant: Ming-Chi HSU, Hsinchu (TW)

(72) Inventor: Ming-Chi HSU, Hsinchu (TW)

(73) Assignee: EPISTAR CORPORATION, Hsinchu (TW)

(21) Appl. No.: 13/451,719

(22) Filed: Apr. 20, 2012

(51) Int. Cl. F21V 7/04; F21V 7/00; F21V 29/00; F21V 11/00; F21V 21/00; F21V 17/12

(52) U.S. Cl. 362/235; 362/249.02; 362/249.06

(57) ABSTRACT

LED lighting fixtures capable of providing even luminous intensity distribution are disclosed. An illustrative lighting fixture includes a base, a pedestal, a substrate, first and second LEDs, and light transmissive cover. The base is in electrical communication with a power source. The pedestal is on the base. Mounted on the pedestal is the backside of the substrate. The first and second LEDs are mounted on the front and back sides of the substrate, respectively. The light transmissive cover substantially encapsulates the substrate and the first and second LEDs.

### BACKGROUND

The present disclosure relates generally to LED lighting fixtures, and more specifically to LED lighting fixtures capable of replacing conventional lighting fixtures.

As well known in the art, there are different kinds of lighting fixtures developed in addition to the familiar incandescent light bulb, such as halogen lights, florescent lights and LED (light emitting diode) lights. LED lighting fixtures have several advantages. For example, LEDs have been developed to have lifespan up to 50,000 hours, about 50 times as long as a 60-watt incandescent bulb. This long lifespan makes LED light fixtures suitable in places where changing bulbs is difficult or expensive (e.g., hard-to-reach places, such as the exterior of buildings). Furthermore, an LED requires minute amount of electricity, having luminous efficacy about 10 times higher than an incandescent bulb and 2 times higher than a florescent light. As power consumption and conversion efficiency are big concerns in the art, it has been a trend for LED lighting fixtures to replace other kinds of lighting fixtures.

Unlike incandescent light bulbs and florescent lights whose lights are omnidirectional, an LED transmits a focused beam of light. Defined by ENERGY STAR, a joint program of the U.S. Environmental Protection Agency and the U.S. Department of Energy, any lighting fixture proclaiming to replace an existing standard omnidirectional lamp or bulb is required to meet specific luminous intensity distribution. FIG. 1 demonstrates a lighting fixture intended to replace omnidirectional lamps or bulbs. There are some requirements for lighting fixtures intended to replace omnidirectional lamps or bulbs. As shown in FIG. 1, the distribution of luminous intensity shall be even with zone Z_{front}, the 0° to 135° zone, (vertically axially symmetrical) and the luminous intensity at any angle within zone Z_{front} shall not differ from the mean luminous intensity for the entire zone Z_{front} by more than 20%. Furthermore, at least 5% of total flux must be emitted in zone Zᵣₑₐᵣ, the 135° to 180° zone, in the proximity of the base contact. Beam reflectors, diffusers, and lens have been employed in LED lighting fixtures, to spread out the focused light beam of an LED. Nevertheless, it is still a challenge for an LED lighting fixture to meet the intensity distribution requirements of ENERGY STAR.

### SUMMARY

Embodiments of the present application disclose a lighting fixture including a base, a pedestal, a substrate, first and second LEDs, and light transmissive cover. The base is in electrical communication with a power source. The pedestal is on the base. Mounted on the pedestal is the backside of the substrate. The first and second LEDs are mounted on the front and back sides of the substrate, respectively. The light transmissive cover substantially encapsulates the substrate and the first and second LEDs.

Embodiments of the present application disclose a lighting fixture including a substrate, first and second LEDs. The substrate is in electrical communication with a power source. The first and second LEDs are mounted on the substrate. The first and second LEDs as a whole are arranged to create a luminous intensity distribution with a top lobe and at least one bottom lobe. The top lobe and the bottom lobe are substantially separated by a plane defined by the substrate. The top lobe and the bottom lobe are different. The first LEDs dominate the top lobe. The second LEDs dominate the bottom lobe.

### BRIEF DESCRIPTION OF THE DRAWINGS

The present application can be more fully understood by the subsequent detailed description and examples with references made to the accompanying drawings, wherein:

FIG. 1 demonstrates a lighting fixture intended to replace omnidirectional lamps or bulbs;

FIG. 2A shows an LED lighting bulb according to an embodiment of the present application;

FIG. 2B shows a cross section of the LED light bulb in FIG. 2A;

FIGS. 3A and 3B illustratively show the front side and the back side of a printed circuit board, respectively, according to one embodiment of the present application;

FIG. 4A illustrates the far-field intensity distribution resulted from an LED lighting bulb when a bulb has not been assembled;

FIG. 4B illustrates the far-field intensity distribution possibly resulted from an LED lighting bulb with a bulb covering thereon;

FIG. 5A shows a cross section of an LED light bulb according to an embodiment of the present application;

FIGS. 5B and 5C show illustratively the front side and the back side, respectively, of the printed circuit board in FIG. 5A;

FIG. 6A shows a LED lighting tube according to an embodiment of the present application;

FIG. 6B demonstrates the front side and the back side of the printed circuit board in FIG. 5A;

FIG. 7 shows an LED lighting bulb according to an embodiment of the present application;

FIG. 8 illustrates the far-field intensity distribution of a single traditional LED emanating upward; and

FIGS. 9A and 9B illustrate two far-field intensity distributions possibly resulted from two LED lighting bulb without covering bulbs according to embodiments of the present application.

### DETAILED DESCRIPTION

The following embodiments are described in sufficient details to enable those skilled in the art to make and use the application. It is to be understood that other embodiments would be evident based on the present disclosure, and that improves or mechanical changes may be made without departing from the scope of the present application.

In the following description, numerous specific details are given to provide a thorough understanding of the present application. However, it will be apparent that the present application maybe practiced without these specific details. In order to avoid obscuring the present application, some well-known configurations and process steps are not disclosed in detail.

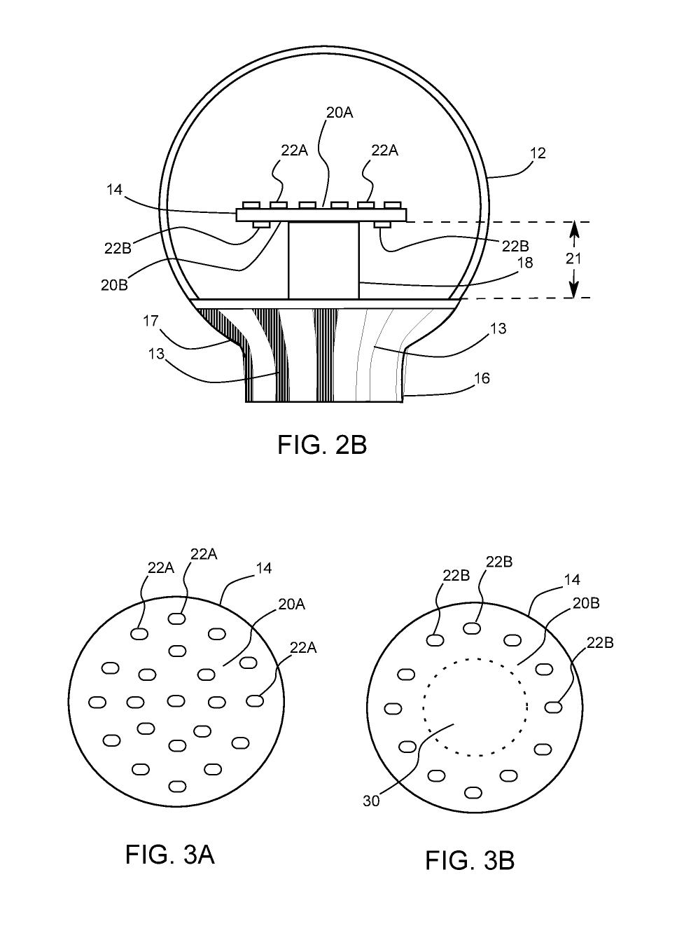

LED lighting bulb 10 according to an embodiment of the present application is shown in FIG. 2A. Across section of LED light bulb 10 is shown in FIG. 2B. LED lighting bulb 10 includes bulb 12, first and second LEDs 22A and 22B, printed circuit board 14, base 16 and pedestal 18.

Printed circuit board 14 in bulb 12 has front side 20A and back side 20B, and is mounted to pedestal 18. LEDs 22A and 22B, in a through-hole or surface-mount type for example, are soldered to mount on front side 20A and back side 20B, respectively. LEDs 22A and 22B are in electrical communication with base 16 adapted for connection to an electrical power source (such as branch circuit, not shown). For example, LED driving circuitry powered (not shown) to drive LEDs 22A and 22B might be encapsulated in base 16. LEDs 22A are configured to shine substantially upward and LEDs 22B are configured to shine substantially backward to base 16. LED lighting bulb 10 may be DC powered (e.g., from a battery, 6-12V) or AC powered (e.g., 110-120 or 220-240 VAC) or solar powered (e.g., connected to a solar cell).

In the non-limiting embodiment of FIG. 2A, base 16 has an Edison male screw base contact 19 that screws into a matching socket. However the application is not limited to this type of contact, and LED lighting bulb 10 may have any other suitable contact, such as but not limited to, a single pin bayonet base, a double pin bayonet base (with one negative and one positive terminal in the base to match two contact points in a corresponding socket), a flange base, an MR16 socket base, or a wired connection.

Pedestal 18 in FIGS. 2A and 2B is connected to heat sink 17 with fins 13. Pedestal 18 and printed circuit board 14 as well could have thermal conductive material to conduct the heat generated by LEDs 22A and 22B to heat sink 17, which dissipates the heat through fins 13.

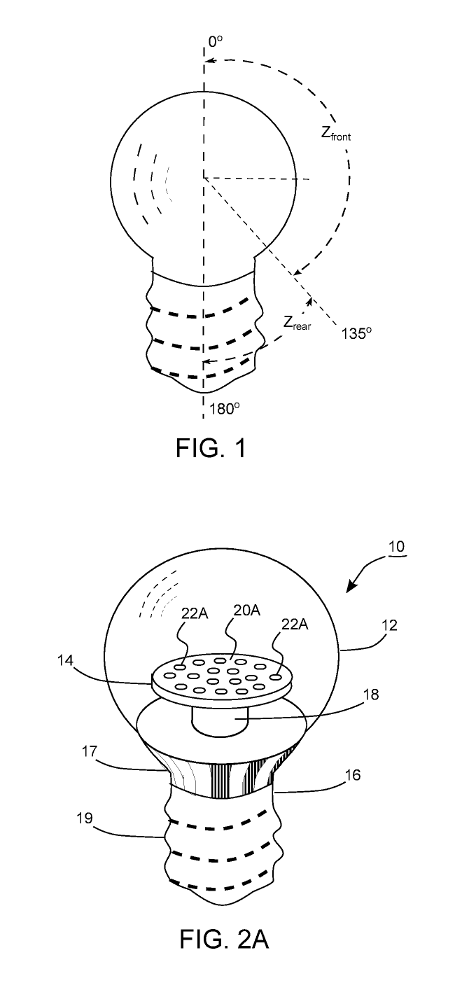

As pedestal 18 protrudes, gap 21 is formed between heat sink 17 and printed circuit board 14. Gap 21 allows LEDs 22B, which shine backward to base 16, to brighten the proximity of base 16, or the 135° to 180° zone in FIG. 1. Adjusting the number or/and arrangement of LEDs 22B in comparison with LEDs 22A could control the luminous intensity distribution of LED lighting bulb 10. FIGS. 3A and 3B illustrate front side 20A and back side 20B of printed circuit board 14, respectively. Mounted substantially in an even pattern on front side 20A are LEDs 22A. Nevertheless, LEDs 22B are mounted on a peripheral region of back side 20B, and arranged in a circular pattern, possibly making the intensity distribution vertically symmetrical. Central region 30 of printed circuit board 14, after assembling, is in contact with pedestal 18.

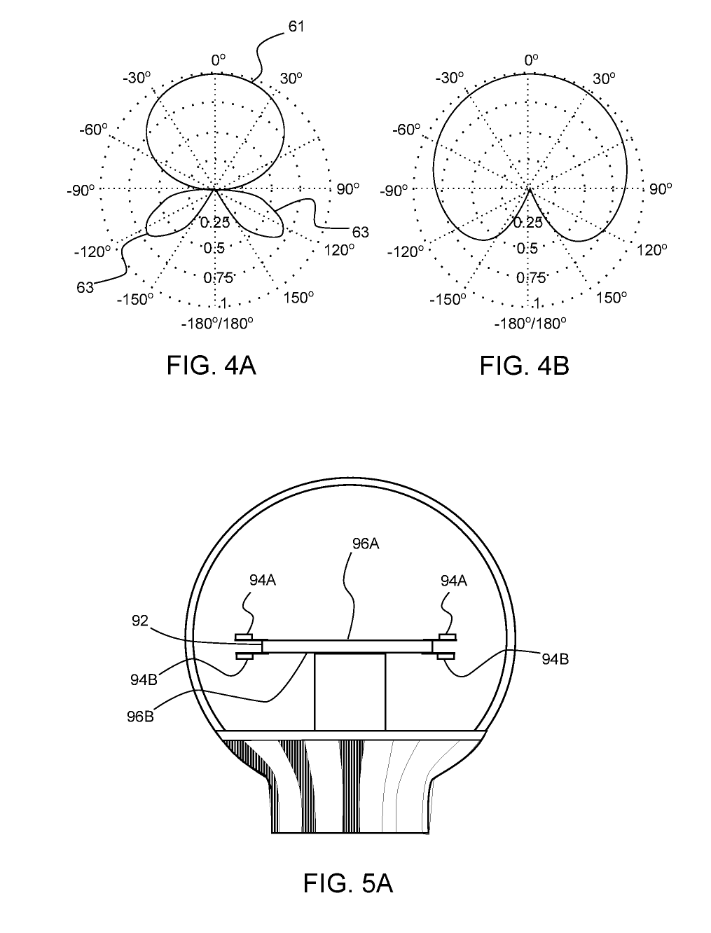

In some embodiments, bulb 12 is transparent or translucent glass encapsulating printed circuit board 14 and LEDs (22A and 22B). Preferably, bulb 12 scatters the light beams from LEDs 22A and 22B to provide a more even intensity distribution. FIG. 4A illustrates the far-field intensity distribution (normalized to its maximum value) resulted from LED lighting bulb 10 when bulb 12 has not been assembled. LEDs 22A are arranged to shine upward, dominating the luminous intensity within the −90° −0° −90° zone, such that the luminous intensity distribution in FIG. 4A has major top lobe 61 at the top half plane, opposite to base 16. LEDs 22B shine backward through the gap 21 between printed circuit board 14 and heat sink 17, and dominate the luminous intensity within both the −90° to −150° and 90° to 150° zones. Accordingly, the luminous intensity distribution in FIG. 4A has two bottom side lobes 63 at the bottom half plane, wherein the bottom side lobes 63 are about around base 16. As shown in FIG. 4A, the plane defined by printed circuit board 14 separates major top lobe 61 from two bottom side lobes 63, and all LEDs 22A and 22B hardly shine at the angles close to 90° and −90°. Furthermore, because LEDs 22A shine upward to an open space while LEDs 22B shine backward but are blocked by the pedestal 18 and base 16 somewhere in a central region, major top lobe 61 is different from bottom side lobes 63. FIG. 4B illustrates the far-field intensity distribution possibly resulted from LED lighting bulb 10 with bulb 12 covering thereon. In this embodiment, FIG. 4B has a more even intensity distribution than FIG. 4A does because bulb 12 scatters the light beams from LEDs 22A and 22B, such that the luminous intensity close to angles 90° and −90° increases.

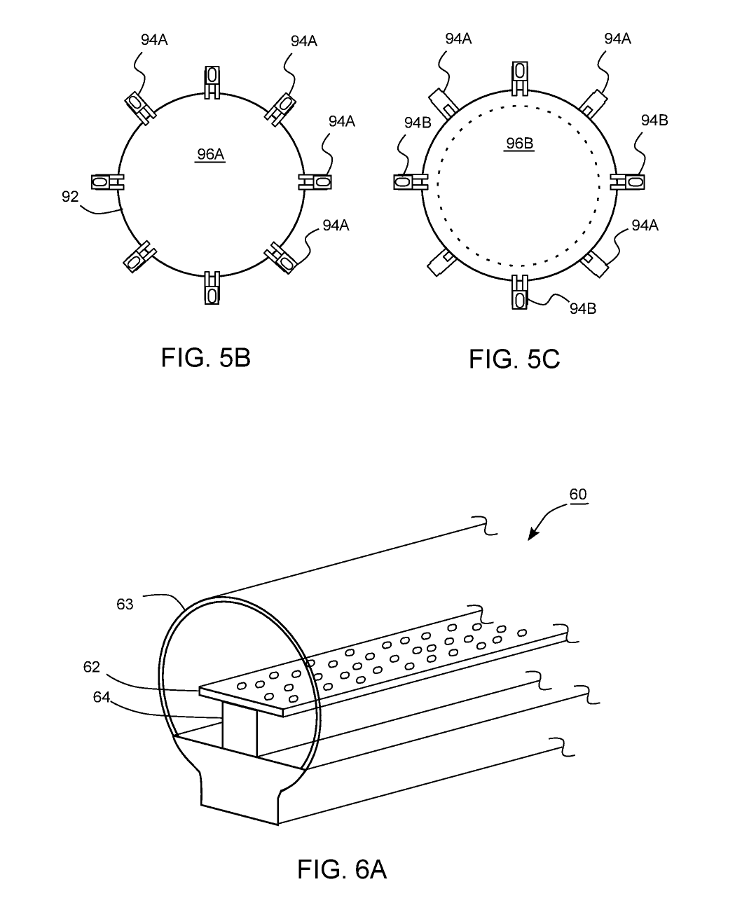

The type of LEDs and the arrangement of LEDs may vary in different embodiments. FIG. 5A shows a cross section of an LED light bulb according to an embodiment of the application. FIGS. 5B and 5C illustrates the front side 96A and back side 96B, respectively, of printed circuit board 92 in FIG. 5A. Each of LEDs 94A and 94B has two legs for electrical connection. LEDs 94A, shining upward, are mounted radically on front side 96A, while their legs cross the edge of front side 96A. Mounted radically at the edge of back side 96B are LEDs 94B shining backward and having legs crossing the edge of back side 96B. Unlike common through-hole LEDs whose cathode and anode legs extend opposite to the direction the LEDs face and shine, LEDs 94A and 94B have cathode and anode legs extending laterally.

As shown in FIGS. 5A, 5B, and 5C, LEDs 94A and 94B are configured to shine upward or backward, and their cathode and anode legs extend in a direction parallel to the printed circuit board 92. LEDs 94A and 94B are suspended in the air by their legs mounted on printed circuit board 92. Even though LEDs 94A and 94B are mounted on the front side 96A and back side 96B of the printed circuit board 92, this application is not limited to. In another embodiment, LEDs are mounted only on a front side of a printed circuit board, some of the LEDs are through-hole or surface-mounted type to face/shine upward, and others are similar with those LEDs of FIGS. 5A, 5B, and 5C, having legs mounted on the front side but facing/shining backward.

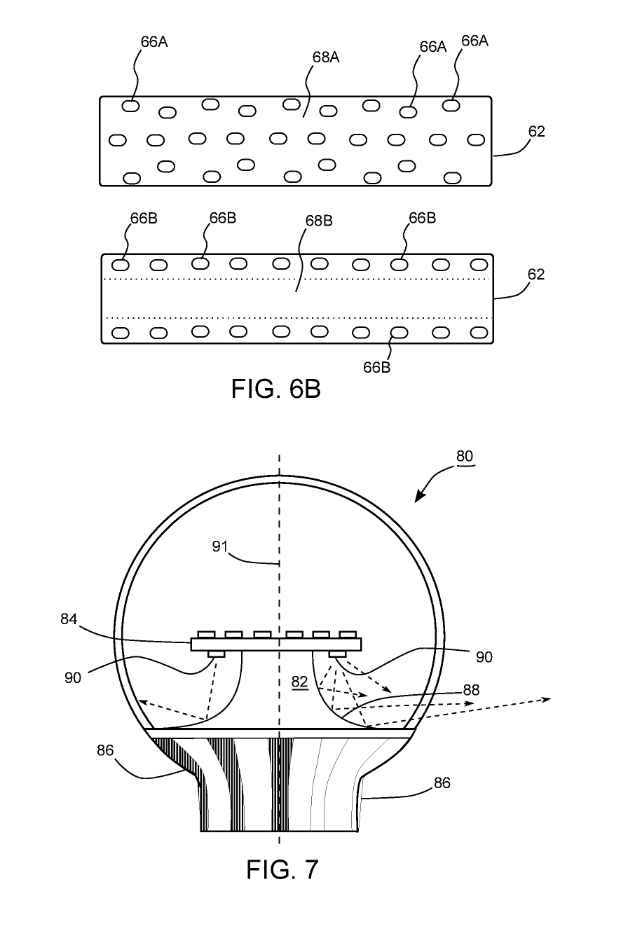

This application is not limited to LED bulbs, nevertheless. FIG. 6A shows an LED lighting tube according to an embodiment of the application. FIG. 6B demonstrates the front side and the back side of printed circuit board 62 in FIG. 6A. LED lighting tube 60 has printed circuit board 62 with back side 68B mounted on pedestal 64, substantially encapsulated in light transmissive cover 63. LEDs 66A are mounted on the front side 68A of printed circuit board 62. LEDs 66B are mounted in peripheral regions adjacent to two opposite edges of the back side 68B. It is obvious for persons skilled in the art that LEDs 66B could shine backward to contribute brightness to the zone around the base of LED lighting tube 60. In a preferred embodiment, light transmissive cover 63 alters the intensity contributed from printed circuit board 62 by scattering the incoming light beams from LEDs.

In some embodiments, the pedestal that supports a printed circuit board has a light reflective surrounding to reflect light beams from the LEDs at the back side of the printed circuit board. It is preferred that some light beams are redirected by the pedestal to an angle about perpendicular to the vertical axis of a bulb. LED lighting bulb 80 according to an embodiment of the present application is shown in FIG. 7. As shown in FIG. 7, pedestal 82 under printed circuit board 84 has a concave reflective surrounding 88. The light beams exemplified in FIG. 7 indicate how LEDs 90 on the back side of printed circuit board 84 shine toward not only the area near base 86 but also the zone near the angle about perpendicular to the axis 91 of pedestal 82. In other embodiments, a pedestal is a truncated cone or a frustum with a reflective surrounding. Even though each of the pedestals shown in the figures of this specification has a bottom face not smaller than the top face, the application is not limited thereto. For example, a pedestal in an embodiment of the application is an upside-down truncated cone or an upside-down frustum.

Each of the printed circuit boards in the aforementioned embodiments functions as a substrate for LEDs to be mounted thereon. In a preferred embodiment, the printed circuit board therein is a metal core PCB to provide better thermal conduction. The printed circuit board could be a double-sided PCB with conductive metal strips or lines printed on the front and back sides. It is, in some embodiments, formed by mounting, back to back, two single-sided PCBs.

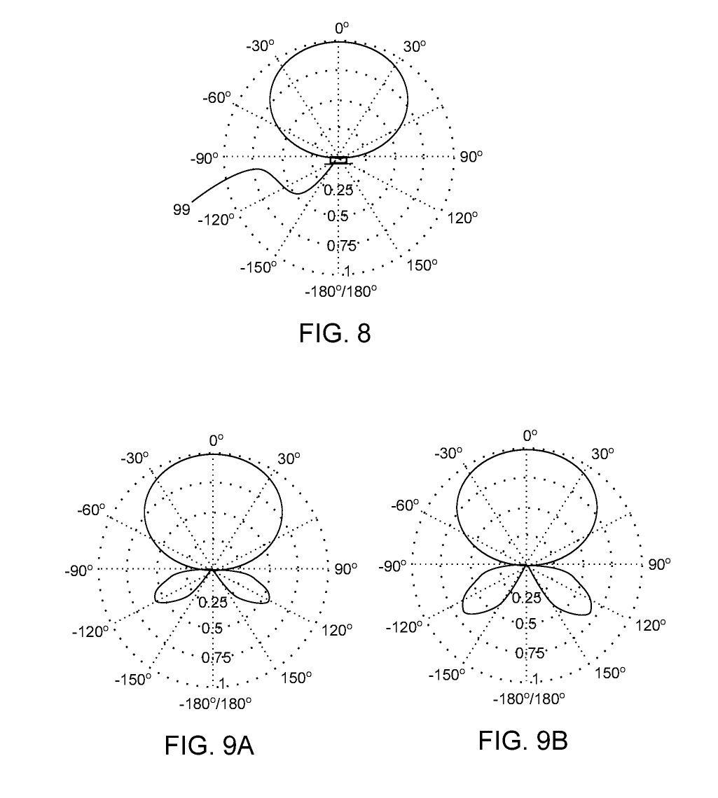

The luminous intensity distribution of a LED lighting fixture according to an embodiment can be determined by the ratio of LEDs shining upward to those shining backward. FIG. 8 illustrates the far-field intensity distribution of a single traditional LED 99 emanating upward. FIGS. 9A and 9B illustrate the two far-field intensity distributions possibly resulted from two LED lighting bulbs without being covered according to embodiments of the application. The LED light bulbs shown in FIGS. 9A and 9B are identical, but the LED light bulb in FIG. 9B has more LEDs shining backward than that for FIG. 9A. The top major lobes in FIGS. 9A and 9B are about the same with the one in the intensity distribution of FIG. 8, as they have the same number of LEDs shining upward. Each intensity distribution of FIGS. 9A and 9B has two bottom side lobes at the bottom half plane, as there are LEDs shining backward. By comparing FIG. 9A with FIG. 9B, it can be found that when the number of the LEDs shining backward increases, the two bottom side lobes enlarge and the top major lobe substantially remains the same.

Embodiments of the application have a printed circuit board upheld by a pedestal of a base while LEDs are mounted on both front and back sides of the printed circuit board. As the LEDs on the back side are capable of contributing luminous intensity to the proximity of the base, fine tuning LEDs arrangement in front and back sides could achieve even luminous intensity distribution, such that a LED lighting fixture of the application could replace a traditional omnidirectional lighting apparatus.

While the application has been described by way of example and in terms of preferred embodiment, it is to be understood that the application is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A lighting fixture, comprising:
a base;
a pedestal on the base;
a substrate comprising a front side and a back side, the substrate being mounted on the pedestal via the back side;
first LEDs, mounted on the front side;
second LEDs, mounted on the back side; and
a cover having a light transmissive portion between the second LEDs and the base.

2. (canceled)

3. The lighting fixture of claim 1, wherein the second LEDs are arranged in a circular pattern.

4. The lighting fixture of claim 1, wherein the second LEDs are mounted on a peripheral region of the back side.

5. The lighting fixture of claim 1, wherein the pedestal is in contact with a central region of the back side.

6-7. (canceled)

8. The lighting fixture of claim 1, wherein the pedestal is connected to a heat sink for heat dissipation.

9. The lighting fixture of claim 1, wherein the pedestal includes a concave reflective surrounding surface.

10. The lighting fixture of claim 1, wherein the cover scatters light beams from the first and the second LEDs.

11. (canceled)

12. The lighting fixture of claim 1, wherein the cover substantially encloses the substrate, the pedestal, and the first and second LEDs.

13. The lighting fixture of claim 1, wherein the first LEDs, the second LEDs, or both comprise at least one LED having a leg extending beyond an edge of the substrate.

14-20. (canceled)

21. The lighting fixture of claim 1, wherein the first LEDs, the second LEDs, or both comprise at least one LED having a leg extending laterally.

22. The lighting fixture of claim 1, wherein the first LEDs face a first direction and have a leg extending in a second direction substantially perpendicular to the first direction.

23. The lighting fixture of claim 22, wherein the second direction is parallel to the substrate.

24. A lighting fixture, comprising:
a substrate; and
first LEDs and second LEDs mounted on the substrate and arranged to create a luminous intensity distribution with a top lobe having a first angle range and a bottom lobe having a second angle range less than the first angle range.

25. The lighting fixture of claim 24, wherein the first angle range is within 180°.

26. The lighting fixture of claim 24, wherein the second angle range is within 60°.

27. The lighting fixture of claim 24, further comprising a base, and a pedestal on the base, wherein the substrate is connected to the pedestal.

28. The lighting fixture of claim 27, wherein the top lobe is opposite to the base; and the bottom lobe is about around the base.

29. The lighting fixture of claim 27, wherein the pedestal includes a reflective surface.

30. The lighting fixture of claim 24, wherein the substrate is a printed circuit board with a front side and a back side, and the second LEDs are arranged in a circular pattern on the back side.
